(19) United States
(12) Patent Application Publication
(10) Pub. No.: US 2006/0114603 A1
(43) Pub. Date: Jun. 1, 2006

(54) Method and apparatus to control airflow in hard disk drives

(75) Inventors: Song Cheh Ser, Singapore (SG); Weng How Leong, Singapore (SG)

Correspondence Address: DAVIDSON BERQUIST JACKSON & GOWDEY LLP, 4300 WILSON BLVD., 7TH FLOOR, ARLINGTON, VA, 22203, US

(73) Assignee: Metalform Asia Pte Ltd, Singapore (SG)

(21) Appl. No.: 11/289,270

(22) Filed: Nov. 30, 2005

(30) Foreign Application Priority Data
Dec. 1, 2004 (SG) 200407250-0

(51) Int. Cl. G11B 33/14

(52) U.S. Cl. 360/97.02

(57) ABSTRACT

A method for reducing air turbulence in a hard disk drive system is provided. The method begins by providing a hard disk drive having a spindle motor to spin a hard disk. When the drive is in operation, the spinning hard disk generates unwanted airflow, which may destabilize a read/write head supported by an actuator arm. By using an air separator having a number of grooves, the airflow may be directed to reduce air turbulence.

### BACKGROUND OF THE INVENTION

1. Field of the Invention

The present invention relates to hard disk drive systems. In particular, it relates to controlling and directing the flow of air within a hard disk drive.

2. Description of the Related Art

Most computers use one or more hard disk drive as the primary mass storage device for digital information. Generally, a hard disk drive includes a hard disk, often referred to as a platter, which is supported by a spindle motor and a read/write device. The hard disk platter has a surface of magnetic film to store data, which may be accessed by the read/write device, also commonly referred to as a head. During operation, the head is positioned over the platter, which is spun by the spindle motor.

Constant research and development to increase the speed and efficiency of the various hard disk drive components have resulted in tremendous advances in the speed of data transfer and storage capacity. Examples of the technological advances include increases in the density of hard disk platters, the rotational speed of the spindle motor, and interface bandwidth between the drives and computers. Inevitably, such improvements come with a price. For example, increasing the rotational speed of the spindle motor requires a great deal more power, particularly to “spin-up.”

The hard drive's spindle speed is extremely important because it is the basis for two measures of hard drive performance. With a faster rotation, not only can more data can be read and written per second, data can also be found more quickly. Unfortunately, increased rotational speeds also have many undesirable results, such as increased heat, vibration, and air turbulence. In particular, the spinning motion of the hard disk platter causes the air turbulence. Because the hard disk drive interior operates under stringent environmental conditions, such turbulence is a threat to safe disk drive operation and may even irreparably damage the drive.

More specifically, because the head is only separated from the hard disk platter by a curtain of air during normal operation, it is extremely sensitive. The turbulence may destabilize the head and cause it to come into physical contact with the hard disk. If such contact is made, the hard disk media is likely irreparably damaged and all of the data stored on the hard disk may be lost. In addition, any destabilization of the head may reduce performance or even cause errors during hard drive operation.

Because engineers continue to increase the rotation speed of hard disks to improve performance, the air turbulence generated by the ever more rapidly spinning disks will also present a growing problem to safe hard drive operation. In view of the foregoing, it is desirable to have a method and an apparatus to control and reduce air turbulence in hard disk drive systems.

### BRIEF DESCRIPTION OF THE DRAWINGS

The present invention will be readily understood by the following detailed description in conjunction with the accompanying drawings. To facilitate this description, like reference numerals designate like structural elements.

FIG. 1 illustrates a top view of a hard disk drive in accordance with one embodiment of the present invention.

FIG. 2 illustrates a top view of the air separator in accordance with one embodiment of the present invention.

FIG. 3 illustrates a cross sectional view of the hard disk drive in accordance with one embodiment of the present invention.

FIG. 4 illustrates four air separators, each having a different set of grooves defined therein in accordance with several embodiments of the present invention.

FIG. 5 illustrates the hard disk drive having an air separator that is further secured to the chassis by an adhesive seal in accordance with several embodiments of the present invention.

FIG. 6 is a flow chart for a method to reduce air turbulence in a hard disk drive system.

### DETAILED DESCRIPTION

A method and apparatus for reducing turbulence in a hard disk drive system are provided. In the following description, numerous specific details are set forth in order to provide a thorough understanding of the present invention. It will be understood, however, to one skilled in the art, that the present invention may be practiced without some or all of these specific details. In other instances, well known process operations have not been described in detail in order not to unnecessarily obscure the present invention.

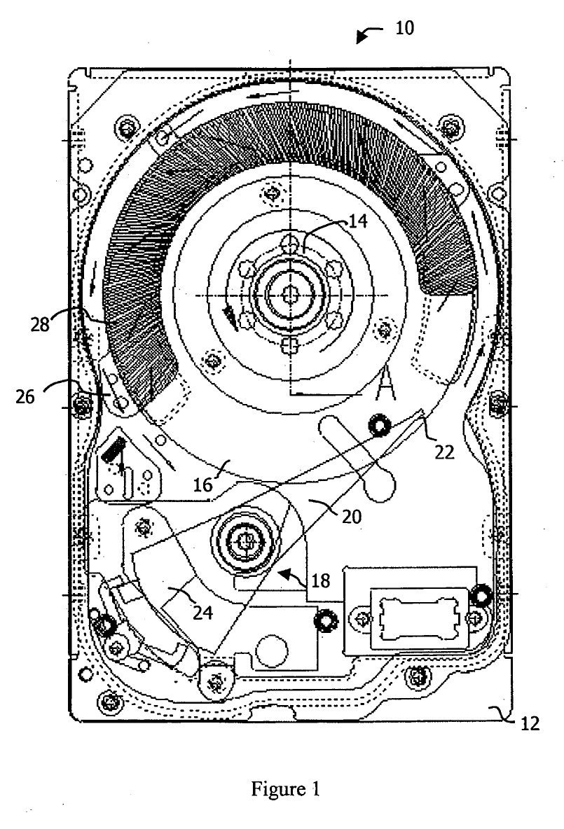

FIG. 1 illustrates a top view of a hard disk drive 10 in accordance with one embodiment of the present invention. Hard disk drive 10 includes a chassis 12 for supporting a spindle motor 14, which is coupled to a hard disk platter 16. Chassis 12, which typically includes a base and a hard drive cover, also supports an actuator assembly 18, which includes an actuator arm 20 for supporting a read/write head 22. Actuator assembly 18 also includes a voice motor coil (VCM) 24, which is coupled to actuator arm 20. Additionally, an air separator 26, having a set of grooves 28, is secured to chassis 12 and positioned over part of hard disk platter 16.

When disk drive 10 is in operation, spindle motor 14 spins hard disk platter 16. At the same time, VCM 24 is used to manipulate actuator arm 20 to position head 22 over spinning hard disk platter 16. As head 22 moves across hard disk platter 16, data may be transferred either from head 22 to platter 16 or vice versa. As is well known in the art, disk drive 10 may include additional platters and heads.

Unfortunately, the rotation of hard disk platter 16 generates unwanted air turbulence, which may destabilize actuator arm 20 and head 22. Because head 22 is extremely sensitive, the turbulence may cause errors during the read/write process. In addition, because head 22 is typically positioned only about or less than two microns away from hard disk platter 16, the turbulence may cause head 22 to come into contact with hard disk platter 16, which may ruin the entire hard drive. Because developers are constantly striving to improve performance by increasing hard disk rotation speed, the spinning disks will likely generate even greater air turbulence in future designs. Therefore, it is increasingly important to reduce the effects of the turbulence.

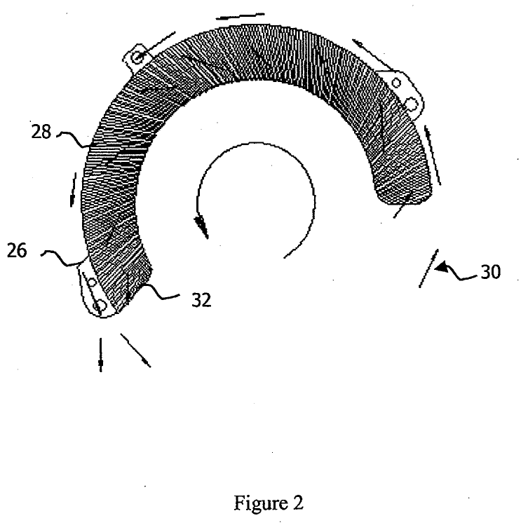

In one embodiment of the present invention, the air turbulence is controlled by grooves 28, which are formed in air separator 26, which is shown in greater detail in FIG. 2. It should be noted that air separator 26 might also be formed as a portion of chassis 12, so that grooves 28 are defined on chassis 12. As hard disk platter 16 spins, a flow of air is generated in the direction of the spinning. Ordinarily, the flow of air would be uninhibited and strike actuator arm 20, potentially causing destabilizing head 22. When the flow of air strikes air separator 26, grooves 28 control and direct the air turbulence away from actuator arm 20 and head 22 as shown by a set of arrows 30.

In this embodiment, air separator 26 is formed with an edge 32 positioned to direct the airflow away from actuator arm 20 and head 22. Additionally, grooves 28 located near edge 32 are used to direct airflow towards VCM 24. During disk drive operation, VCM generates heat, which causes a loss of efficiency in the drive's performance. The airflow, which may be directed through a filter, then aids in cooling VCM 24 and removing the undesired heat.

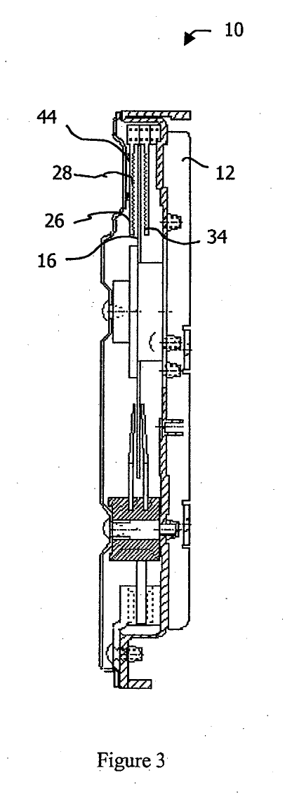

FIG. 3 illustrates a cross sectional view of hard disk drive 10 in accordance with one embodiment of the present invention. As shown, hard disk drive 10 further includes an air separator 34 secured to chassis 12. Air separator 34 is positioned under part of hard disk platter 16 on the opposite side of air separator 26. The combination of the two air separators 26 and 34 provide control of air turbulence generated on both sides of hard disk platter 16. An adhesive 44, which is described in more detail below, may be used to secure air separator 26 to the top cover of chassis 12.

Both air separators 26 and 34 include grooves 28 defined therein to direct airflow away from actuator arm 20 and head 22 and towards VCM 24. While, grooves 28 (not shown to scale in FIG. 3) may vary in size, in one embodiment, grooves 28 may have a width of between about 0.3 microns and about 0.5 microns. Grooves 28 may also have a depth of between about 0.3 microns and 0.5 microns. Grooves 28 may also be defined in a number of different shapes and patterns on air separators 26 and 34, as will be described in further detail below.

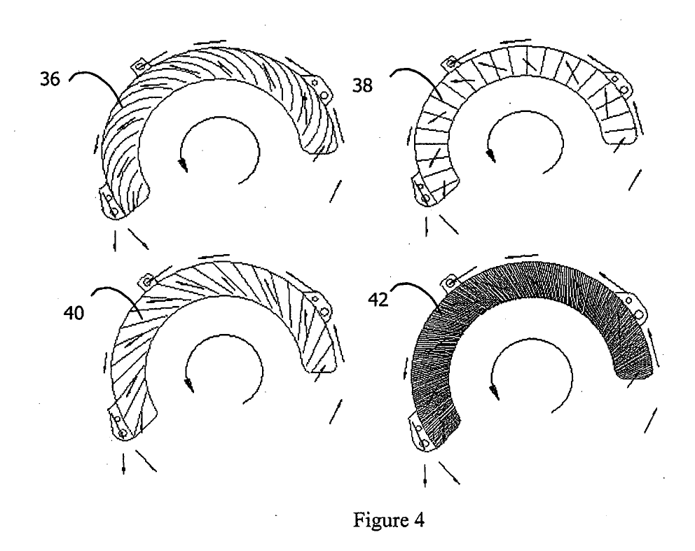

FIG. 4 illustrates four air separators, each having a different set of grooves 36, 38, 40, and 42 defined therein in accordance with several embodiments of the present invention. It should be understood that the groove patterns shown are merely exemplary and that other groove patterns may be used. Grooves 36 are curved and define a spiral pattern around the air separator. Grooves 38 are straight and defined at a normal to the interior and exterior edges of the air separator. Grooves 40 are straight and define a spiral pattern, while grooves 42 are similar to grooves 40, but are formed in a pattern with a much higher density. Grooves 40 and 42 may be formed at an angle between about 40 degrees and about 60 degrees with the interior edges of the air separators.

While the grooves illustrated in FIG. 4 are useful to reduce air turbulence, hard disk drives also generate vibration that may rattle the air separators. Referring to FIG. 1, air separator 26 is typically secured to chassis 12 with a number of screws. However, despite these measures, air separator 26 may still experience excessive vibration during hard drive operation.

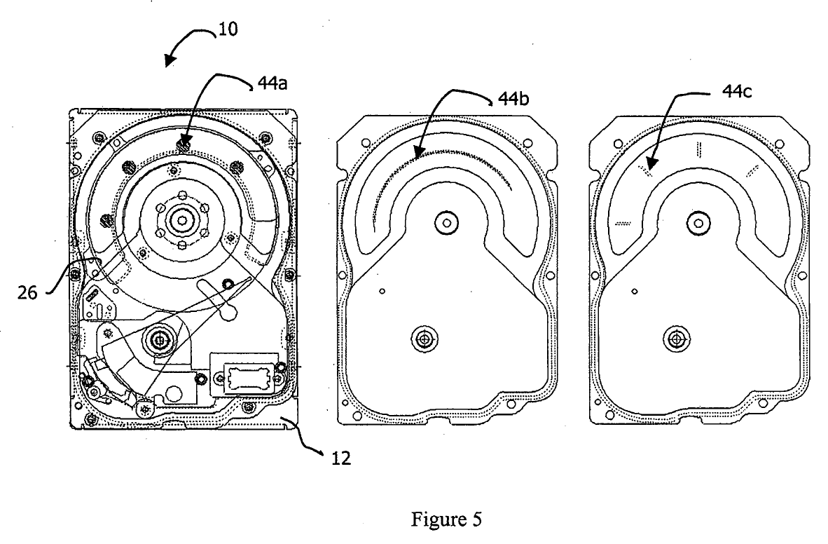

FIG. 5 illustrates hard disk drive 10 having an air separator 26 that is further secured to chassis 12 by an adhesive seal 44 in accordance with several embodiment of the present invention. Adhesive seal 44 may be disposed between the top of air separator 26 and chassis 12 to provide additional support to prevent air separator 26 from vibrating. In one embodiment, adhesive seal 44 may be a form in place gasket (FIPG) material. The FIPG may be applied in a variety of patterns, including a dot pattern 44a, a curved strip 44b, or a set of straight strips 44c.

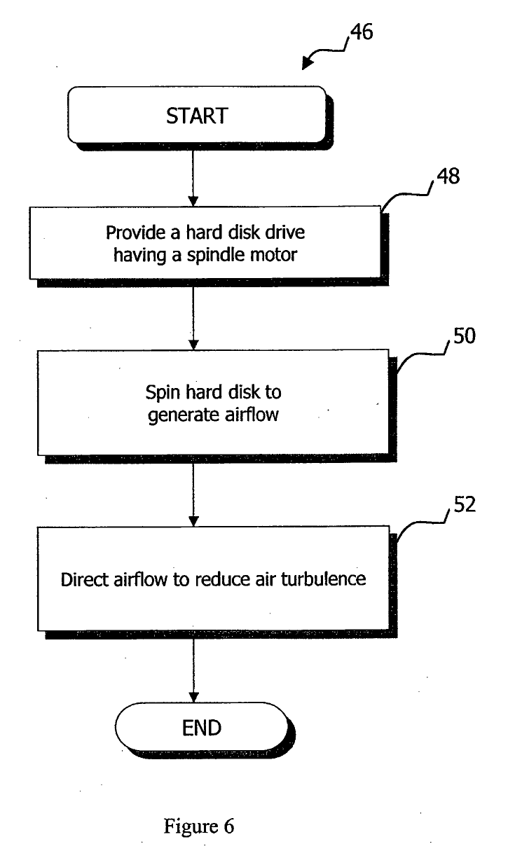

FIG. 6 is a flow chart for a method 46 to reduce air turbulence in a hard disk drive system. Method 46 begins at a block 48 in which a hard disk drive having a spindle motor to support and spin a hard disk is provided. During operation, the spindle motor spins the hard disk, which generates airflow in a block 50. Using a set of grooves formed on an air separator disposed over the hard disk, the airflow is then directed to reduce air turbulence in a block 52. More specifically, the airflow may be directed away from the read/write head, which is positioned over the hard disk. The airflow may also be directed towards the VCM to provide cooling.

Other embodiments of the invention will be apparent to those skilled in the art from consideration of the specification and practice of the invention. Furthermore, certain terminology has been used for the purposes of descriptive clarity, and not to limit the present invention. The embodiments and preferred features described above should be considered exemplary, with the invention being defined by the appended claims.

1. A method for reducing air turbulence in a hard disk drive system, comprising:
providing a hard disk drive having a spindle motor to spin a hard disk;
spinning said hard disk to generate airflow; and
directing said airflow with a plurality of grooves formed on an air separator to reduce air turbulence.

2. The method as recited in claim 1, wherein the airflow is directed away from a read/write head, wherein said read/write head is supported by an actuator assembly and positioned over a surface of the hard disk.

3. The method as recited in claim 2, wherein the read/write head is positioned less than about 2 microns from the surface of the hard disk.

4. The method as recited in claim 3, wherein the grooves form an angle of between about 40 degrees to about 60 degrees relative to an interior surface of the air separator.

5. The method as recited in claim 4, wherein the grooves have a width of between about 0.3 microns and 0.5 microns.

6. The method as recited in claim 5, wherein the grooves have a depth of between 0.3 microns and 0.5 microns.

7. The method as recited in claim 3, wherein the air separator is secured to the chassis with form in place gasket material.

8. The method as recited in claim 3, wherein the airflow is directed towards a voice coil motor.

9. A hard disk drive system for reducing air turbulence therein, comprising:
a chassis coupled to a spindle motor, wherein said spindle motor is to spin a hard disk;
an actuator assembly coupled to said chassis, wherein said actuator assembly is to support a read/write head; and
an air separator coupled to said chassis, wherein said air separator includes a plurality of grooves to direct airflow to reduce air turbulence.

10. The hard disk drive system as recited in claim 9, wherein the airflow is directed away from the read/write head, wherein the read/write head is positioned over a surface of the hard disk.

11. The hard disk drive system as recited in claim 10, wherein the read/write head is positioned less than about 2 microns from the surface of the hard disk.

12. The hard disk drive system as recited in claim 11, wherein the grooves form an angle of between about 40 degrees to about 60 degrees relative to an interior surface of the air separator.

13. The hard disk drive system as recited in claim 12, wherein the grooves have a width of between about 0.3 microns and 0.5 microns.

14. The hard disk drive system as recited in claim 13, wherein the grooves have a depth of between 0.3 microns and 0.5 microns.

15. The hard disk drive system as recited in claim 12, wherein the airflow is directed towards a voice coil motor.

16. The hard disk drive system as recited in claim 12, wherein the air separator is formed as a portion of the chassis.

17. The hard disk drive system as recited in claim 9, wherein the air separator is secured to the chassis with form in place gasket material.

18. A hard disk drive system for reducing vibration therein, comprising:
a chassis coupled to a spindle motor, wherein said spindle motor is to spin a hard disk;
an actuator assembly coupled to said chassis, wherein said actuator assembly is to support a read/write head; and
an air separator coupled to said chassis, wherein said air separator is secured to said chassis with an adhesive.

19. A hard disk drive system as recited in claim 18, wherein the adhesive comprises form in place gasket material.

20. A hard disk drive system as recited in claim 18, wherein the air separator includes a plurality of grooves to direct airflow to reduce air turbulence.
